(19) United States
(12) Patent Application Publication
(10) Pub. No.: US 2012/0217411 A1
(43) Pub. Date: Aug. 30, 2012

(54) RADIATION IMAGING APPARATUS, STAND FOR RADIATION IMAGING APPARATUS AND RADIATION IMAGING SYSTEM

(75) Inventor: Tetsuo Watanabe, Utsunomiya-shi (JP)

(73) Assignee: CANON KABUSHIKI KAISHA, Tokyo (JP)

(21) Appl. No.: 13/398,569

(22) Filed: Feb. 16, 2012

(30) Foreign Application Priority Data
Feb. 25, 2011 (JP) 2011-040322

(51) Int. Cl. G01J 1/42

(52) U.S. Cl. 250/394

(57) ABSTRACT

A radiation imaging system includes a first radiation imaging apparatus having an imaging plane of a first size and a cooperation unit which cooperates with an external apparatus and is arranged at a common distance from a center portion of one side of the imaging plane and a second radiation imaging apparatus including a second imaging plane equal in length to one side of the imaging plane and different in size from the imaging plane and a cooperation unit arranged at the common distance from the center portion of the one side equal in length.

### BACKGROUND OF THE INVENTION

1. Field of the Invention

The present invention relates to a radiation imaging apparatus and, in particular, to a radiation imaging apparatus including a cooperation unit cooperating with an external apparatus.

2. Description of the Related Art

An apparatus which irradiates an object with radiation and detects the intensity distribution of the radiation transmitted through the object to acquire the radiation image of the object has been widely used in the field of industrial nondestructive inspection and medical diagnosis. An apparatus which captures a digital image in which a radiation image is digitized using the semiconductor sensor discussed in Japanese Patent Application Laid-Open No. 08-116044 has been developed for use to capture such an image. The apparatus has become widely used because it has a very wide dynamic range and can momentarily output an image. The apparatus is primarily comprised of a radiation image capturing unit for capturing an image and a control unit for controlling the image capturing unit to capture an image and displaying the captured image on a display device, such as an LCD or CRT monitor. A conventional analog film is contained in a housing called a cassette.

In recent years, a portable radiation imaging apparatus has been in demand to enable a portion of a wide area to be quickly imaged. The radiation imaging apparatus incorporates a sensor for converting radiation into an image signal in a housing in place of analog film and can be referred to as an electronic cassette. A communication cable has been used between the radiation imaging apparatus and the control unit to display an image in real time. The communication cable gets in the way of moving the apparatus and installing the image capturing unit in a desired attitude to impair operability. A wireless radiation imaging apparatus discussed in Japanese Patent Application Laid-Open No. 2003-210444 has been designed to solve the problems in corporation with improvement in communication performance using wireless.

Meanwhile, various stands are prepared to position a portable radiation imaging apparatus to a human subject with the stands matching a desired image capturing form. A stand for imaging a chest in a standing state or a rack for imaging in a recumbent state are examples of above. In general, a cassette with an imaging plane large enough to suit a portion to be imaged has been used. A portable radiation imaging apparatus with an imaging plane different in its size has been in demand to enable selecting an imaging plane different in its size (the size of an imaging plane can be referred to as “field size”).

A radiation generation apparatus is provided with a storage unit including a mechanism for adjusting a position to a different size to accurately match the position in the center of an imaging plane. In general, the storage unit is formed of a large number of metallic components.

However, the positional relationship of a cooperation portion requiring cooperation with an external apparatus such as a wireless communication unit and a power supply unit with the apparatus is different for each of a plurality of radiation imaging apparatus with imaging planes different in its size, so that the handling is difficult.

Further, if the radiation imaging apparatus is supported with a stand, there is a problem that the storage unit formed of metallic components deteriorate external communication performances. Furthermore, if the radiation imaging apparatus is supported with a stand, a power supplying port for supplying power to the radiation imaging apparatus from the outside may not be well connected to the radiation imaging apparatus.

### SUMMARY OF THE INVENTION

The present invention is directed to stabilizing the cooperation of the cooperation units of a plurality of the radiation imaging apparatus with different imaging planes with external apparatus.

According to an aspect of the present invention, a radiation imaging system includes a first radiation imaging apparatus including an imaging plane and a cooperation unit which cooperates with an external apparatus and is arranged at predetermined distance from a center portion of one side of the imaging plane and a second radiation imaging apparatus including a second imaging plane equal in length to the one side of the first imaging plane and different in size from the first imaging plane and a cooperation unit arranged at the predetermined distance from the center portion of the one side equal in length.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B illustrate plan views of a first radiation imaging apparatus according to a first exemplary embodiment.

FIGS. 2A and 2B illustrate plan views of a second radiation imaging apparatus according to the first exemplary embodiment.

FIG. 3 is a explanatory view of a typical stand.

FIGS. 4A and 4B are schematic diagrams in which the first radiation imaging apparatus according to the first exemplary embodiment is attached to the stand.

FIGS. 5A and 5B are schematic diagrams in which the second radiation imaging apparatus according to the first exemplary embodiment is attached to the stand.

FIG. 6 is a schematic diagram illustrating a storage unit in the stand according to a second exemplary embodiment.

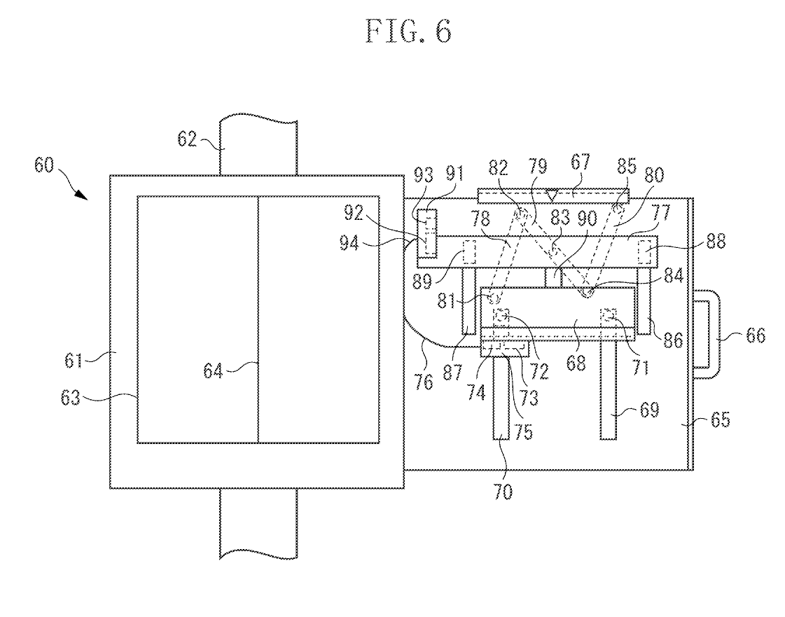

FIGS. 7A and 7B are schematic diagrams in which the first radiation imaging apparatus is attached to the stand according to the second exemplary embodiment.

FIG. 8 is a schematic diagram in which the second radiation imaging apparatus is attached to the stand according to the second exemplary embodiment.

FIGS. 9A and 9B are schematic diagrams illustrating the combination of the radiation imaging apparatuses used in a third exemplary embodiment.

FIG. 10 is a schematic diagram illustrating a storage unit of a stand in the third exemplary embodiment.

FIGS. 11A and 11B are schematic diagrams illustrating the combination of the radiation imaging apparatuses used in a fourth exemplary embodiment.

FIG. 12 is a schematic diagram illustrating the power supply unit in the fourth exemplary embodiment.

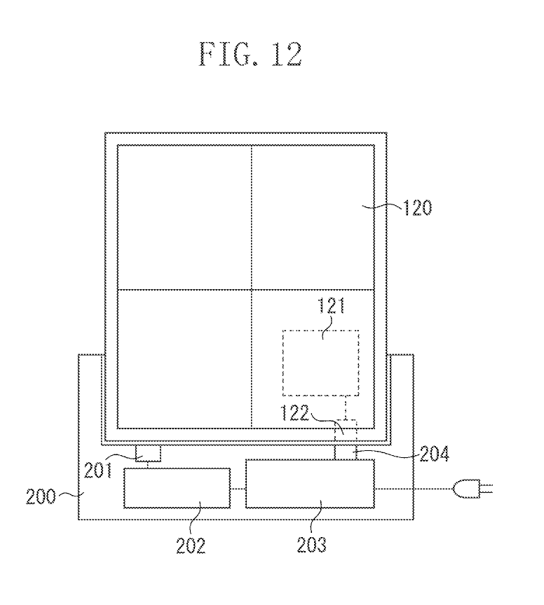

### DESCRIPTION OF THE EMBODIMENTS

Various exemplary embodiments, features, and aspects of the invention will be described in detail below with reference to the drawings.

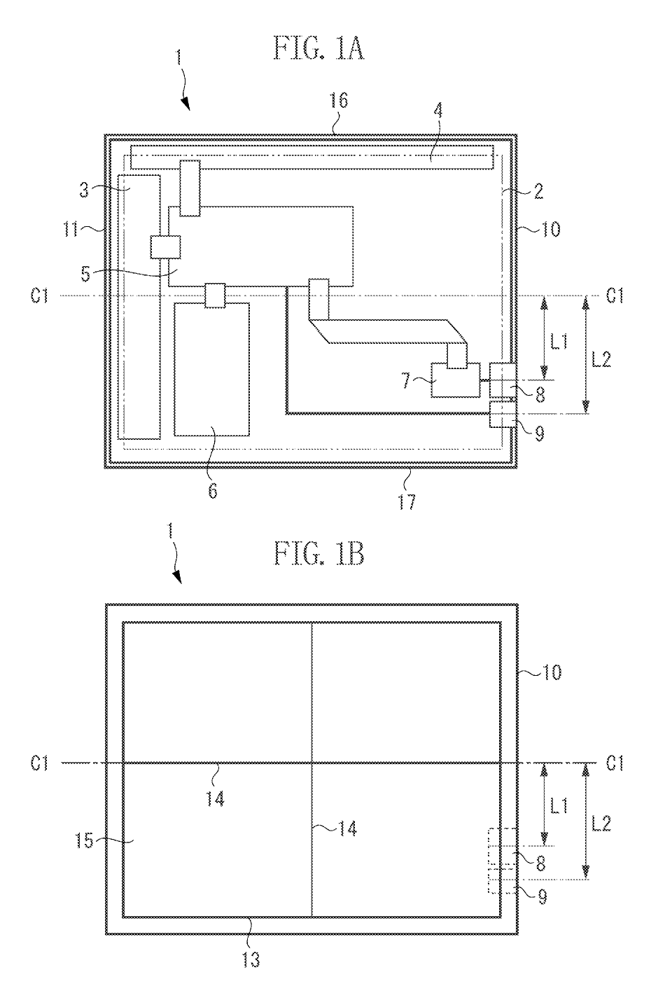

A first exemplary embodiment is described below. FIGS. 1A and 1B illustrate an electronic cassette 1 being a first radiation imaging apparatus incorporating a sensor 2 being a detection unit. The sensor 2 detects radiation generated by a radiation generation apparatus (not illustrated) and transmitted through an object. Upon detecting the radiation incident thereupon, the sensor converts the radiation into an image signal by photoelectric conversion elements arranged in a two dimensional grid to generated a radiation image. An area where the photoelectric conversion elements are two-dimensionally arranged forms a first imaging plane. The first imaging plane is generally located at a source to image-receptor distance (SID). The SID is a measurement of the distance between the radiation source and the radiation detector (sensor). SID parameters for each type of radiographic operation are generally available from sources of standardized and regulatory information, such as the U.S. Food and Drug Administration (FDA). Accordingly, the SID can be adjusted depending on the type of radiography being performed. The size of the imaging plane that receives radiation from the radiation generating apparatus (radiation source) can be referred to as field size. The field size can be fixed or variable depending on collimation of a radiation beam generated by the radiation source.

The image signal acquired by the electronic cassette 1 is transferred as a digital image to an external control apparatus. The acquired image is displayed on a display apparatus, such as an LCD display or CRT monitor, and used for diagnosis. FIG. 1A illustrates a schematic diagram of an internal electric circuit. The electronic cassette 1 includes the sensor 2 and a housing structure configured to enclose therein a reading circuit 3 for acquiring the output from the photoelectric conversion elements in the sensor 2 and a drive circuit 4 for driving the photoelectric conversion elements in the sensor 2 and controlling the output thereof. The housing structure further encloses a control unit 5 for controlling an imaging operation of the electronic cassette 1 including the reading circuit 3 and the drive circuit 4, and for communicating with the external apparatus. A battery unit 6 for supplying electric power may also be enclosed within the housing structure. In the housing are further arranged a wireless communication circuit 7 for transferring control and image signals to and from the control circuit 5 and an infrared communication unit 9 for transferring and receiving control commands and parameters to and from the control circuit 5.

The housing structure is configured in a substantially parallelepiped shape having two opposing (facing) contour sides 10 and 11 which are substantially parallel to each other, and shorter that two other sides 16 and 17 respectively perpendicular thereto. The reading circuit 3 is arranged on a contour side 11 at a distance from opposing contour side 10 of the housing. At the contour side 10 of the housing, the wireless communication circuit 7 and an antenna 8 are formed. In this manner, an image-signal radio wave emitted from the communication circuit 7 and antenna 8 is prevented from interfering with reading operations of reading circuit 3.

As illustrated in FIG. 1B, the incidence plane of radiation in the housing of the electronic cassette 1 is covered by a cover with a good radiation transmittance. Index mark 13 is formed on the outer edge of the incidence plane of the electronic cassette 1 to match the irradiation range of radiation incident thereupon, and index marks 14 (orthogonal lines bisecting the incidence plane in four equal parts) mark the center of the incident radiation. On the contour side 10 of the electronic cassette 1, the antenna 8 and the infrared communication unit 9 are arranged at positions spaced apart from each other. Specifically, antenna 8 is located at a distance L1 from a field centerline C1, the infrared communication unit 9 is located at a distance L2 greater than distance L1 from the center line C1. A field center is also the center of the imaging plane. The field centerline C1 also indicates the centerline of the imaging plane of the sensor 2.

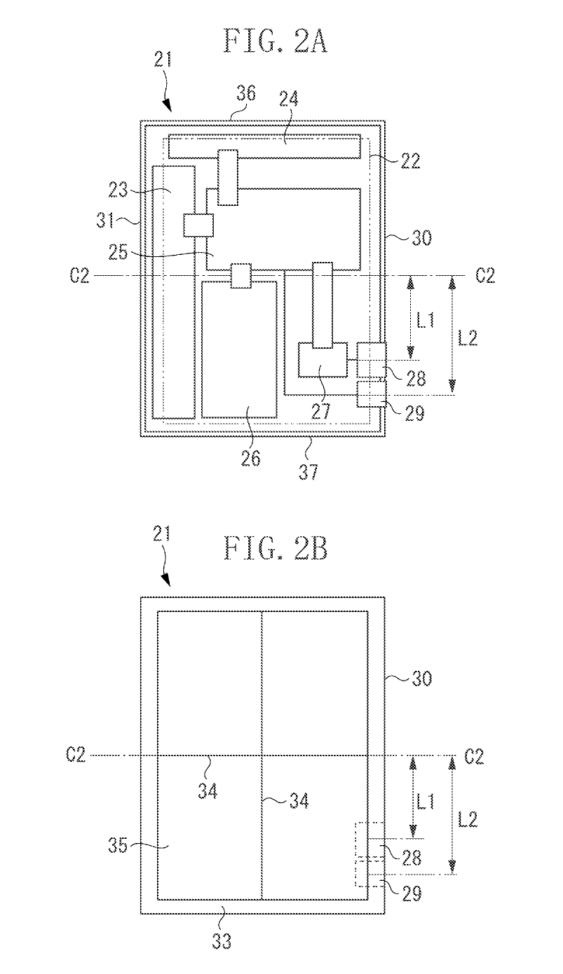

An electronic cassette different in its field size according to an image capturing form has been in demand. Accordingly, FIGS. 2A and 2B, disclose an exemplary embodiment of a different size than the electronic cassette 1 disclosed in FIGS. 1A and 1B. In FIG. 2A, an electronic cassette 21 structurally similar to the electronic cassette 1, but different in size is illustrated. Specifically, the electronic cassette 21 includes a housing structure 35 configured in a substantially parallelepiped shape having two opposing (facing) contour sides 30 and 31 which are substantially parallel to each other, and longer than two other sides 36 and 37 respectively perpendicular thereto. In FIG. 2A, the electronic cassette 21 includes the sensor 22, and the housing structure 35 which is configured to enclose therein a reading circuit 23 for acquiring the output from the photoelectric conversion elements in the sensor 22 and a drive circuit 24 for driving the photoelectric conversion elements in the sensor 22 and controlling the output thereof. The housing structure 35 further encloses therein a control unit 25 for controlling an imaging operation of the electronic cassette 21 including the reading circuit 23 and the drive circuit 24, and for communicating with the external apparatus. A battery unit 26 for supplying electric power may also be enclosed within the housing structure. In the housing are further arranged a wireless communication circuit 27 for transferring control and image signals to and from the control circuit 25 and an infrared communication unit 29 for transferring and receiving control commands and parameters to and from the control circuit 25.

Further, as illustrated in FIGS. 2A and 2B, in an electronic cassette 21 being a second radiation imaging apparatus with a second imaging plane (an imaging plane of a size different than the imaging plane of first radiation imaging apparatus), a communication unit is formed on the longer side 30. As illustrated in FIG. 2B, the incidence plane of radiation in the housing 35 of the electronic cassette 21 is covered by a cover with good radiation transmittance. Index mark 33 is formed on the outer edge of the incidence plane of the electronic cassette 21 to match the irradiation range of radiation incident thereupon, and index marks 34 (orthogonal lines bisecting the incidence plane in four equal parts) mark the center of the incident radiation. On the longer side 30 of the electronic cassette 21, the antenna 28 and the infrared communication unit 29 are arranged at positions spaced apart from each other. Specifically, antenna 28 is located at a distance L1 (same distance L1 as in FIG. 1B) from a field center line C2, and the infrared communication unit 29 is located at a distance L2 (same distance L2 as in FIG. 1B) greater than distance L1 from the center line C2. Accordingly, the communication units of the second radiographic imaging apparatus are arranged at positions spaced apart from a field center line C2 by the same dimensions L1 and L2 as those in the electronic cassette 1. In other words, the communication units are arranged at positions spaced apart by common distances L1 and L2 from the center portion of one side of the second imaging plane. The predetermined distances L1 or L2 from a center portion of the one short side 10 of the housing 15 in the first electronic cassette (radiation imaging apparatus) 1 are equal to the predetermined distances L1 or L2, respectively, from a center portion of the one long side 30 of the housing 35 in the second electronic cassette (radiation imaging apparatus) 21.

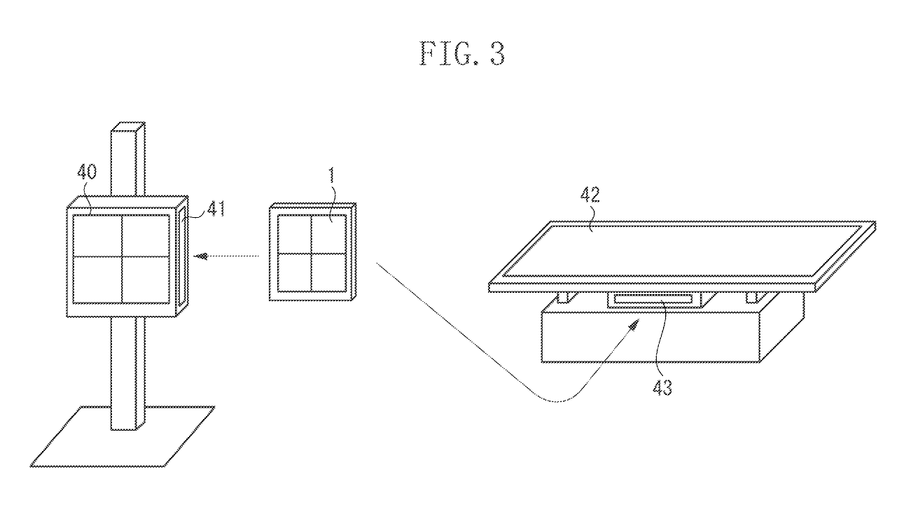

When a radiation image is actually captured, a positional relationship between the electronic cassette 1 and a human subject to be imaged needs to be changed according to an area to be captured or a state of the subject. For this reason, various stands are used to keep constant a state where the electronic cassette 1 is positioned with respect to the human subject. FIG. 3 illustrates typical stands such as a upright stand 40 used for imaging a part of the subject (e.g., chest) in a standing state, and an horizontal stand 42 (table type) used for imaging a chest and an abdominal region in a lying (supine or prone) position being a recumbent position.

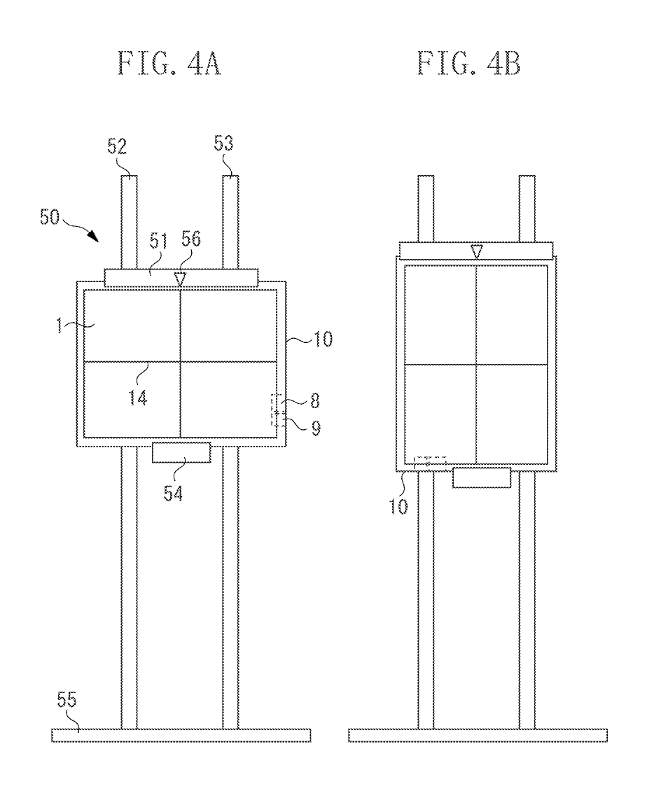

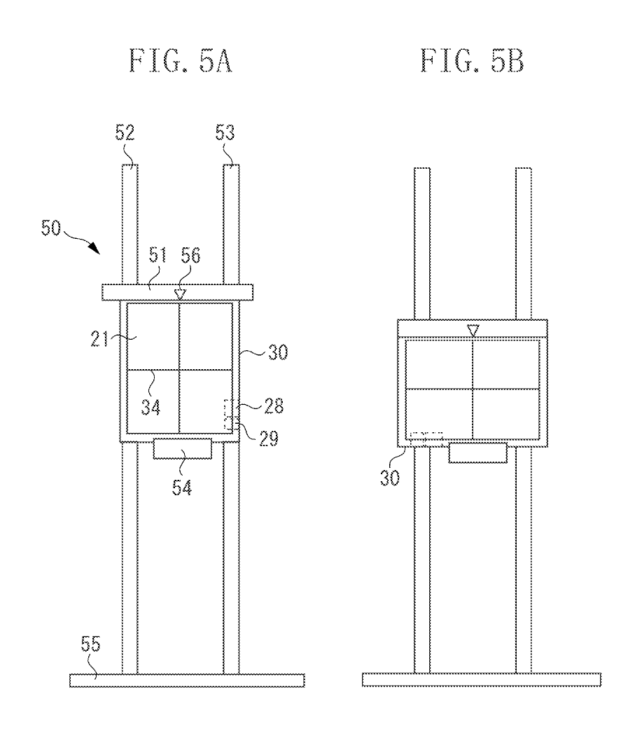

The electronic cassettes 1 and 21 can be selected according to an image capturing form and used in interchangeable manner. The electronic cassette is inserted into an insertion port 41 provided on a vertical side of the upright stand 40, or inserted into an insertion port 43 provided in the front side of the horizontal stand 42, and used for capturing an image. In the present exemplary embodiments, a radiation imaging system using a Lieder's radiographic stand, as an example of an upright stand, is described with reference to FIGS. 4A and 4B and FIGS. 5A and 5B. The radiation imaging system includes a first and a second radiation imaging apparatus, which are different in the size of their imaging planes, and a single stand that can accommodate either one of the first and second radiation imaging apparatus in an interchangeable manner. To that end, the stand includes an adjustable frame (storage unit) movable in a vertical direction.

The storage unit of a Lieder's radiographic stand 50 being a stand for storing the electronic cassette 1 includes horizontal frames 51 and 54 arranged at the upper and lower portions of the Lieder's radiographic stand 50. These frames are vertically adjustably supported by two supporting post 52 and 53 standing on a pedestal 55. At least, the upper frame 51 is formed to be movable in a vertical direction, so that a position thereof may be vertically adjusted to accommodate different sizes of an electronic cassette. In this manner, the electronic cassette is interchangeably held between the upper and lower frames. An index 14 of the electronic cassette 1 is matched to an index 56 provided on the frame 51 so that the field center being the center position of the imaging plane of the electronic cassette 1 coincides with the center of the stand. Thus, installation is performed with the field center caused to coincide therewith. In other words, installation is performed with the center position of the imaging plane of the electronic cassette 1 caused to coincide with the center of the stand being a predetermined position.

In a case where the electronic cassette 1 is arranged in a horizontally long manner so that the short side 10 is positioned on the right side of the stand (as seen in FIG. 4A), the long side of the electronic cassette 1 are mounted on the frames 51 and 54. In this manner, the communication unit such as the antenna 8 and the infrared communication unit 9 that arranged on the short side 10 are held in a position free of obstacles. In such conditions, the wireless and infrared communication channels can communicate with the external apparatus without interference.

In contrast, in a case where the electronic cassette 1 is arranged in a vertically long manner so that the short side 10 is positioned on the lower side as illustrated in FIG. 4B, the frames 51 and 54 cover the short side where the communication unit is arranged. Accordingly, the frames 51 and 54 need to be prevented from interfering with the communication unit to ensure an optimal communication path. For this reason, in the present exemplary embodiment, the length of the lower frame 54 is made short with respect to that of the upper frame 51 to open a communication unit.

The present exemplary embodiment focuses attention on the fact that the center of the imaging plane of the radiation imaging apparatus is positioned at the center of radiation generated by the radiation generation apparatus.

In the present exemplary embodiment, even if the imaging planes are different in size, the size of a side of the imaging planes is equalized and the antenna 8 or 28 and infrared communication unit 9 or 29 (referred herein interchangeably as “a cooperation unit” or “connecting unit”) are arranged at a distance common to each radiation imaging apparatus from the center portion of the side. Thereby, the antenna 8 and the infrared communication unit 9 being the cooperation unit simply stabilize cooperation with the external apparatus. In addition, as understood by persons having ordinary skill in the art, both the infrared communication unit 9 or 29 and antenna 8 or 28 operate to connect the radiation imaging apparatus to the external apparatus, those these components can be collectively referred to as a connection unit.

FIGS. 5A and 5B illustrate examples in which the electronic cassette 21 is attached to the aforementioned Lieder's radiographic stand 50. In the electronic cassette 21 being the second radiation imaging apparatus, the distances L1 and L2 at which the communication unit is arranged from the field center line C2 of the electronic cassette 21 are common irrespective of the size of the imaging plane (field size). In other words, the length of the frame 54 is shorter than the double of the distances L1 and L2, so that the frame 54 can be formed on both of the electronic cassettes in such a position that the communication unit is not covered. Such a configuration allows stable communication even if the electronic cassette different in size of the imaging plane (field size) is arranged in any positions both vertically or horizontally illustrated in FIGS. 4A, 4B, 5A and 5B.

A second exemplary embodiment is described below. Other than the low-cost Lieder's radiographic stand 50 described in the first exemplary embodiment, there is also a stand which incorporates a movement unit for a grid for suppressing scattering rays incident on the electronic cassette and a photo timer for controlling the amount of irradiation. Such a stand incorporates the grid movement unit and the photo timer and is provided with a storage unit for storing the electronic cassette. The storage unit has a housing structure for including the electronic cassette therein. The plane on which radiation is incident is opened and covered by a cover with a good radiation transmittance. The housing itself generally uses a steel material which hardly transmits radiation backward with respect to the direction at which radiation is incident and is high in mechanical strength.

Since the electronic cassette is included in such a metallic housing, the communication path of the communication unit such as wireless and infrared incorporated in the electronic cassette is shielded. Furthermore, the grid and the photo timer are arranged on the radiation incident side which is electromagnetically opened, so that an obstacle increases on the path. Due to such a factor, if the electronic cassette is attached to the storage unit wireless transfer performance and infrared communication is interfered. The present exemplary embodiment describes an example in which a radio repeater or an infrared communication unit being a relay unit for relaying with the external apparatus is incorporated in the space of each storage unit.

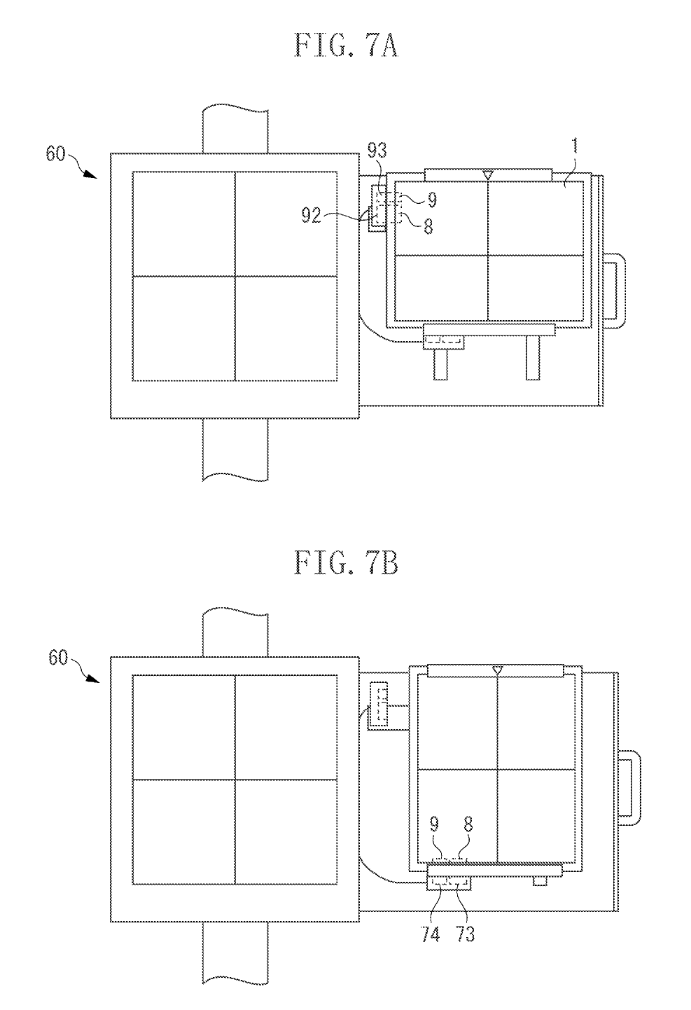

A stand 60 which supports the electronic cassette 1 being the first radiation imaging apparatus and used for capturing an image in a standing position can be vertically moved with respect to a supporting post 62 standing on a pedestal (not illustrated). Indexes 63 and 64 are formed on a storage unit 61 for including the electronic cassette 1 to match an incident radiation to the position of the electronic cassette 1. In the storage unit 61 is provided a drawer unit 65 supported so that the drawer unit 65 can be drawn to the side. At the time of attaching the electronic cassette 1, the drawer unit 65 is put in and taken out from the storage unit 61 with a handle gripped. A mechanism for positioning the electronic cassette to coincide with the indexes 63 and 64 is provided on the drawer unit 65. The electronic cassette 1 is held by horizontal frames 67 and 68 arranged at the upper and lower portions of the drawer unit 65. The lower frame 68 is supported via guides 71 and 72 and is movable vertically along grooves 69 and 70. The lower frame member 68 is urged upward by a spring (not illustrated). The electronic cassette 1 is pinched between the upper and lower frame members 67 and 68 by a spring force. On the lower frame member 68 is provided an external relay unit 75 equipped with a radio repeater 73 and an infrared communication unit 74 at a position opposing the communication unit of the electronic cassette 1. The external relay unit 75 is connected to a cable 76 to communicate with an external control unit (not illustrated). As illustrated in FIG. 7A, in a case where the electronic cassette 1 is arranged in a vertically long manner, the communication unit of the electronic cassette 1 is positioned with the communication unit arranged on the frame member of the stand, so that a stable communication can be ensured.

Meanwhile, in the drawer unit 65 is formed a frame member 77 whose position is adjusted to the center between the upper and lower frame members 67 and 68. A plate 78 is linked to the lower frame member 68 by a fulcrum 81. A plate 79 is coupled to the plate 78 by a fulcrum 82 and a plate 80 is coupled to the plate 79 by a fulcrum 84. The plate 80 is linked to the drawer unit 65 by a fulcrum 85. The frame member 77 is supported movably along grooves 86 and 87 via guide members 88 and 89. A guide 83 provided in the plate 79 and a groove 90 prohibit the frame member 77 from moving leftward or rightward, so that the frame member 77 is always adjusted to the center between the upper and lower frame members 67 and 68 even when the lower frame member 68 moves.

A second external relay unit 91 is formed which can move leftward or rightward along the frame member 77. The external relay unit 91 is provided with a radio repeater 92 and an infrared communication unit 93 at a position opposing the communication unit of the electronic cassette 1 and connected to an external apparatus via a cable 94.

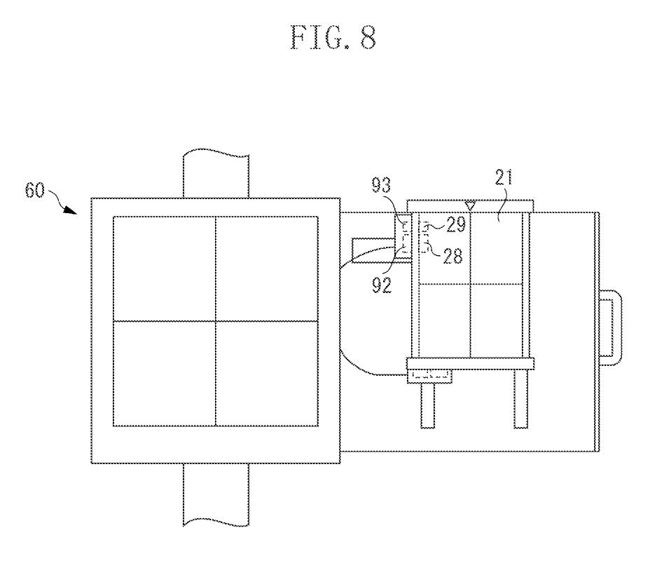

Such a configuration allows the electronic cassette 1 to be arranged in a horizontally long manner as illustrated in FIG. 7A and the electronic cassette 1 to be arranged in a vertically long manner as illustrated in FIG. 7B. Even in such a case, the antenna 8 and the infrared communication unit 9 of the electronic cassette are positioned with the radio repeater 73 or 92 and the infrared communication unit 74 or 93 arranged in the drawer unit of the stand. Thereby, a stable communication can be ensured. As illustrated in FIG. 8, even in a case where the electronic cassette 21 being the second radiation imaging apparatus different in field size is attached, mutual external communication units can be opposed to a radio antenna 28 and an infrared communication unit 29 as is the case with FIGS. 7A and 7B.

Attitude in which the electronic cassette is attached can be recognized by grasping the infrared communication unit capable of communication. The diaphragm setting of a radiation tube can be automatically adjusted based on the information about the attitude of the recognized electronic cassette.

The present exemplary embodiment focuses attention on the fact that the center of the imaging plane of the radiation imaging apparatus stored in the storage unit is positioned at the center of radiation generated by the radiation generation apparatus.

In the present exemplary embodiment, even if the imaging planes are different in size, the size of one side of the imaging planes is equalized and a cooperation unit being a portion cooperating with an external apparatus is arranged at a distance common to the radiation imaging apparatuses from the center portion of the side. Thereby, the radio antenna 28 and the infrared communication unit 29 being the cooperation unit cooperating with the external apparatus simply stabilize cooperation with the external apparatus.

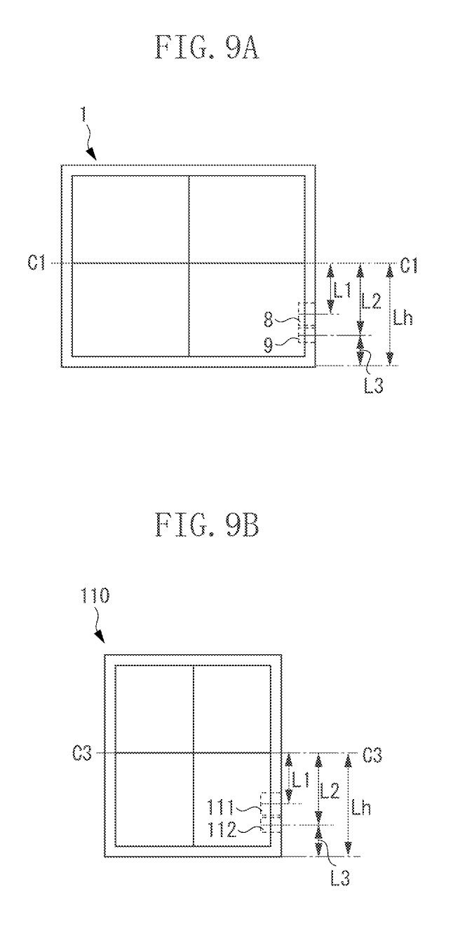

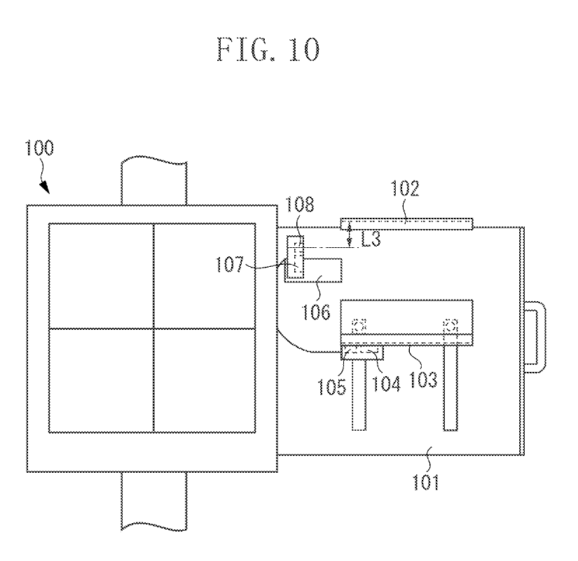

A third exemplary embodiment is described below. As illustrated in FIGS. 9A and 9B, in the electronic cassette descried in the present exemplary embodiment, the short side of the electronic cassette 1 being a first radiation imaging apparatus is equal in length to the long side of the electronic cassette 110 being a second radiation imaging apparatus. Thus, the electronic cassettes are combination having an arrangement of the communication units provided on these sides being completely matched. If the field size of the electronic cassette is taken as 43 cm×35 cm (which is referred to as half-cut sheet of detector) and the electronic cassette is taken as 35 cm×28 cm (which is referred to as quarter-cut sheet of detector), which can cover many of image capturing manipulations. The use of such a combination makes common a distance L3 from the contour end of the electronic cassette to the infrared communication unit in both of the electronic cassettes. For this reason, the stand to which the electronic cassette is attached eliminates the need for adjusting the height of the communication unit by the frame member 77 as described in the second exemplary embodiment. For this reason, in a stand 100 illustrated in FIG. 10, a radio antenna 107 and an infrared communication unit 108 are supported movably leftward and rightward with respect to a frame 106. The infrared communication unit 108 is arranged so that a distance from a upper frame 102 becomes equal to L3 to realize a stable communication. In addition, the arrangement of a reading circuit on the common side enables the reading circuit to be commonly used for each electronic cassette, which is industrially advantageous in terms of cost.

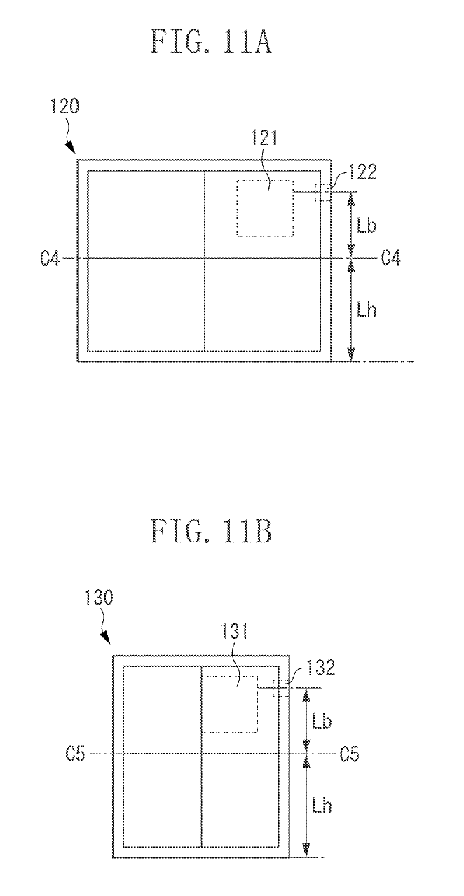

A fourth exemplary embodiment is described below. The above exemplary embodiments discuss the communication unit provided on the electronic cassette, but the present exemplary embodiment treats an electronic cassette equipped with a power supply function. As illustrated in FIGS. 11A and 11B, power supply units 122 and 132 for charging incorporated batteries 121 and 131 respectively are formed at the ends of a short side of an electronic cassette 120 and a long side of an electronic cassette 130. As is the case with the third exemplary embodiment, the short side of the electronic cassette 120 is equal in length to the long side of the electronic cassette 130. An external power supply unit is placed in a common positional relationship so that a distance from the center to the external power supply unit becomes equal to Lb.

If the electronic cassette is not in use or the battery therein has been discharged, a power supply unit 200 for charging the battery is prepared. The electronic cassettes 120 or 130 in which a power supply is provided inserted into an attachment port opened at the upper portion of the power supply unit 200 with the short side of the electronic cassette 120 or the long side of the electronic cassette 130 taken as a head. On the bottom of the attachment port is arranged an external supply unit 204 at a position where the external supply unit 204 coincides with the power supply units 122 and 132. When a detection unit 201 detects that the electronic cassette is attached, a control circuit 202 issues instructions to a power supply 203 and an external power supply unit 204 starts supplying power to the electronic cassette. A power supply unit for supplying power by an electrical contact or an electromagnetic inductive non-contact can be used as the external power supply unit 204.

Thus, even if the imaging planes are different in size, the size of one side of the imaging planes is equalized and the power supply units 122 and 132 being a portion cooperating with an external apparatus is arranged at a distance common to the radiation imaging apparatuses from the center portion of the side.

Thereby, the position where the external power supply unit 204 can be used is made common to the electronic cassette with a plurality of field sizes to allow a stable supply state to be maintained and the external power supply unit 204 can act as a common power supply unit.

Thus, an example can be proposed in which charging can be realized by replacing the communication unit in the first and second exemplary embodiments with an external power supply unit even with the electronic cassette attached to the stand.

In the above exemplary embodiments, although radio and infrared communication are used as a communication means, a connector with an electric contact may be used.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-040322 filed Feb. 25, 2011, which is hereby incorporated by reference herein in its entirety.

What is claimed is:

1. A radiation imaging system comprising:
a first radiation imaging apparatus including an imaging plane and a cooperation unit cooperating with an external apparatus, the cooperation unit being arranged at a predetermined distance from a center portion of one side of the imaging plane; and
a second radiation imaging apparatus including a second imaging plane equal in length to the one side of the first imaging plane and different in size from the first imaging plane and a cooperation unit arranged at the predetermined distance from the center portion of the one side equal in length.

2. The radiation imaging system according to claim 1, further comprising a stand configured to interchangeably hold the first and the second radiation imaging apparatuses and arrange the side equal in length and a center position of the first and second imaging planes at a predetermined position.

3. The radiation imaging system according to claim 2, wherein the stand includes a storage unit configured to store therein either of the first radiation imaging apparatus or the second radiation imaging apparatus and a relay unit configured to relay communication between the cooperation unit and the external apparatus in case where the radiation imaging apparatus is stored in the storage unit.

4. The radiation imaging system according to claim 2, wherein the stand comprises an external power supply unit configured to supply electric power to one of the first or second radiation imaging apparatus.

5. The radiation imaging system according to claim 1, wherein the stand further comprises frames configured to hold one of the first or second radiation imaging apparatus with a center position of the imaging plane thereof matched with a predetermined position of the stand,
wherein the length of one of the frames is shorter than the double of the common distance.

6. The radiation imaging system according to claim 1, wherein the cooperation unit is any one of a radio antenna, an infrared communication unit, and a power supply unit.

7. A radiation imaging apparatus held by a stand which places center positions of imaging planes of a plurality of the radiation imaging apparatuses with the imaging planes different in size at a predetermined position, the radiation imaging apparatus comprising:
a sensor configured to capture a radiation image of an object through a two-dimensional imaging plane;
a control unit configured to control the sensor;
a communication unit configured to communicate by radio between the control unit and an external apparatus; and
a housing configured to house a detection unit and the control unit and arrange the communication unit at a distance common to the plurality of radiation imaging apparatuses from a center portion of one side of the imaging plane equal in length.

8. The radiation imaging apparatus according to claim 7, wherein the radiation imaging apparatus has the imaging plane with one of a size of 43 cm×35 cm or 35 cm×28 cm and provides the communication unit at a distance common to the plurality of radiation imaging apparatuses from a center portion of the side of 35 cm.

9. The radiation imaging apparatus according to claim 7, further comprising a reading circuit configured to read an image signal from the sensor and arranged at the side opposite to the one side where the communication unit is arranged.

10. The radiation imaging apparatus according to claim 7, further comprising:
a reading circuit configured to read an image signal from the sensor; and
a drive circuit configured to control the output of the sensor;
wherein the reading circuit is arranged at the side opposite to the one side of the imaging plane where the communication unit is arranged.

11. The radiation imaging apparatus according to claim 7, wherein the communication unit is a radio antenna.

12. The radiation imaging apparatus according to claim 7, wherein the communication unit is a wireless communication circuit.

13. The radiation imaging apparatus according to claim 7, wherein the communication unit is an infrared communication unit.

14. A stand for a radiation imaging apparatus including a communication unit communicating with an external apparatus comprising:
a storage unit configured to store the radiation imaging apparatus; and
an external relay unit configured to relay communication between a communication unit of the radiation imaging apparatus stored in the storage unit and the external apparatus.

15. A radiation imaging system, comprising:
a stand having an adjustable frame, and
a plurality of radiation imaging apparatuses,
wherein a first radiation imaging apparatus includes a radiation sensor and a housing having a parallelepiped shape with two short sides opposing to each other and two long sides perpendicular to the two short sides, the first radiation imaging apparatus having an imaging plane of a first size and a connection unit arranged at a predetermined distance from a center portion of one short side of the housing,
wherein a second radiation imaging apparatus includes a radiation sensor and a housing having a parallelepiped shape with two long sides opposing each other and two short sides perpendicular to the two long sides, the second radiation imaging apparatus having an imaging plane of a second size different than the first size and a connection unit arranged at a predetermined distance from a center portion of one long side of the housing,
wherein the predetermined distance from a center portion of the one short side of the housing in the first radiation imaging apparatus is equal to the predetermined distance from a center portion of the one long side of the housing in the second radiation imaging apparatus.

16. The radiation imaging system according to claim 15, wherein the adjustable frame is movable in a vertical direction so that only one of the first and second radiation imaging apparatuses can be held therein in an interchangeable manner.

17. The radiation imaging system according to claim 16, wherein the connection unit in the first or second radiation imaging apparatus includes a wireless communication unit configured to connect the first or second radiation imaging apparatus, respectively, to the external apparatus, and
wherein the connection unit in the first or second radiation imaging apparatus is positioned at same side of the stand regardless of whether the first or second radiation imaging apparatus is being held therein in the stand.
